(19) United States
(12) Patent Application Publication
(10) Pub. No.: US 2008/0103811 A1
(43) Pub. Date: May 1, 2008

(54) Postal security system

(76) Inventor: Nestor Sosa, Chatsworth, CA (US)

Correspondence Address: TY UNG, 16830 VENTURA BLVD., SUITE 360, ENCINO, CA, 91436, US

(21) Appl. No.: 11/980,964

(22) Filed: Oct. 30, 2007

Related U.S. Application Data
(60) Provisional application No. 60/856,088, filed on Nov. 1, 2006.

(51) Int. Cl. G06Q 50/00; G06F 17/30

(52) U.S. Cl. 705/1

(57) ABSTRACT

The present invention is a postal security system for preventing identity theft, market profiling, and similar other activities. The present invention solves these problems by limiting access to the physical postal address of a user by assigning these physical postal addresses a virtual address, or also referred to as a security code, that can be used when transacting with merchants and other people.

### CROSS-REFERENCE TO RELATED APPLICATION

This application claims priority to provisional application No. 60/856,088 filed on Nov. 1, 2006.

### FEDERALLY SPONSORED RESEARCH

Not Applicable

### SEQUENCE LISTING OR PROGRAM

Not Applicable

### BACKGROUND OF THE INVENTION

The present invention relates to a security system, and more particularly a security system used to hide the physical postal address of a user when transactions are made, especially when the transaction are purchases made online.

Since the advent of the postal system, people are weary of using their physical postal address in personal and business transactions for fear of stalkers, angry clients, or the mass mailers. To avoid these issues, many people buy a PO Box from the post office or from a private company such as Mailboxes, etc. These PO Boxes provide people the ability to receive mail without the worry of having their home address disclosed to unwanted eyes.

However, with a PO Box, the owner's of the boxes are required to go to the PO Box at least once a month, if not more frequent. Because of this hassle, most people do not use a PO Box and those that do, may lose their PO Box address because they failed to make the payment for the box. As a result, they would have to obtain a different PO Box address and change all correspondence to this new address. Therefore, there is a need to provide a better method of providing security to people by concealing their physical postal address and avoiding the hassle of making the trip to their PO Box.

### SUMMARY OF THE INVENTION

The present invention is a postal security system for preventing identity theft, market profiling, and similar other activities. The present invention solves these problems by limiting access to the physical postal address of a user by assigning these physical postal addresses security codes, or virtual addresses, that can be used when transacting with merchants and other people.

The virtual address, which consists of codes, corresponds to the physical postal address of a user. When the user wants to perform a transaction, such as the purchase of an item from an online merchant, the user enters the virtual address into the address field or a similar field in the order form. After the transaction is completed, the virtual address is sent to the merchant or a shipper. The merchant or shipper enters the virtual address into the database containing the virtual address and its corresponding physical postal address. The merchant or shipper sign up for membership with the database owner prior to accessing the database. The physical postal address is then used to deliver the item to the user without ever having the information disclosed online or to anyone other than the person performing the shipping.

### BRIEF DESCRIPTION OF THE FIGURES

FIG. 1 is an illustration of an address field with data entries made by a user, including the user's address information.

FIG. 2 is an illustration of an address field with a virtual post box designator entered as the address field.

### DETAILED DESCRIPTION

The novel features of the present invention will become apparent from the following description of a preferred embodiment of the invention. The present invention is a postal security system for preventing identity theft, market profiling, and similar other activities.

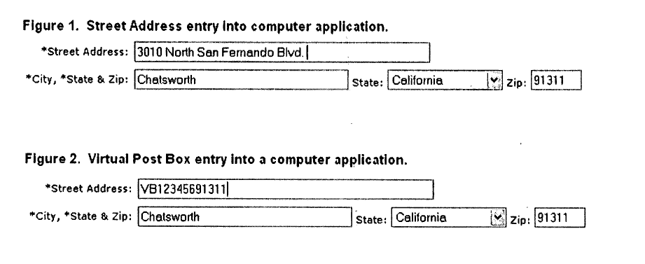

The security system comprises a database and a means for retrieving information from the database. The database comprises physical postal addresses to be protected and virtual addresses, also referred to as a security code, corresponding to the physical postal addresses. A user enters an address as shown in FIG. 1. A virtual address is then assigned to the physical postal address as shown in FIG. 2. The virtual address may consist of a 13-character, computer-generated alphanumeric character.

The first two characters, located in position 1 and 2, of the virtual address are constant values that identifies the entry in a street address field of a computer application as a virtual address rather than a physical postal address. The virtual address provides a means to identify the physical postal address location of a user, and can be easily distinguished by human or machine. The city, state, and zip code information, as shown in FIG. 2, is optional since the virtual address coding contains all the information needed to determine the physical postal address between a shipper and the virtual address provider.

The next six characters of the virtual address, which are randomly generated and located at positions three through eight, identify the corresponding postal address with the record in the database. The last five characters, located in position nine through thirteen, comprise the zip code of the corresponding postal address.

A retrieving means comprises an application program interface which links to the database containing the virtual address and the corresponding postal address. The application program interface allows a user to retrieve a physical postal address from the database by inputting the corresponding virtual address. To use the security system, a customer or user first purchases a virtual address. Once a user has purchased the virtual address, the virtual address and the corresponding physical postal address are entered into a database. Thereafter, during online shopping sessions, the user enters the virtual address into the address field of the order form instead of their physical postal address, especially when shopping online.

When a product is purchased and ready for shipping, the merchant or shipper receives the appropriate virtual address from the information provided on the order where the product is purchased. The merchant or shipper, who also needs to subscribe to the security system which provides access to the database through the application program interface, retrieves the corresponding physical postal address by inputting the virtual address. Once the postal address is retrieved, the product is delivered to the customer's physical address without fear of identity theft or other similar types of fraud, which are a commonplace during online shopping.

Additionally, a check digit method for may be included to validate the address for accuracy. This reduces the transmission errors or data capture errors. The check digit method may be similar to check digit methods used on other types of identification numbers such as UPC, credit cards, or ISBN. Other methods may also be used.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

What is claimed is:

1. A postal security system to reduce identity theft, market profiling, and other unauthorized activities, comprising:
(a) a virtual address corresponding to a postal address.

2. The postal security system of claim 1, further comprising a database for storing and maintaining the postal addresses to the corresponding virtual address.

3. The postal security system of claim 1, wherein the virtual address consists of alphanumeric characters.

4. The postal security system of claim 1, wherein the first two characters of the virtual address identifies the address as a virtual address.

5. The postal security system of claim 4, further comprising randomly generated characters that identifies the corresponding postal address within the database.

6. The postal security system of claim 5, wherein the randomly generated code are located from a third to eighth position.

7. The postal security system of claim 6, wherein a zip code is located from a ninth to thirteenth position.

8. The postal security system of claim 2, further comprising a means of retrieving postal address from the database when the corresponding security code is inputted.

9. The postal security system of claim 8, wherein the means for retrieving the postal address from the database is an application program interface which links to the database containing the virtual address and the corresponding postal address.

10. A method of using the postal security system of the present invention comprising the steps of:
(a) A consumer entering a virtual address into an address field of an order form;

11. The method of claim 10, wherein the virtual address is sent to a merchant to be processed.

12. The method of claim 11, wherein the merchant retrieves a postal address for the consumer by entering the virtual address into an application interface linked to a database containing the virtual address and the corresponding postal address.

13. The method of claim 12, wherein the merchant is required to sign up for access to the database.

14. The method of claim 12, further comprising a check digit method for validating the accuracy of the virtual address.

15. The method of claim 12, wherein the merchant delivers the product to the customer using the postal address retrieved from the database.

16. A method of providing a virtual address comprising the step of:
(a) a user entering a postal address during the purchase of the virtual address;
(b) a computer generates the virtual address by assigning alphanumeric characters to the postal address.

17. The method of claim 16, wherein the physical address and corresponding virtual address are stored in a database for retrieval of the physical address when the corresponding virtual address is entered into an application program interface.

18. The method of claim 16, wherein the virtual address consists of thirteen characters.

19. The method of claim 18, wherein a first two positions of the virtual address is the virtual address identifier, a third through eighth position are randomly generated alphanumeric that identify the corresponding postal address with the record in the database, and a ninth through thirteenth position comprises the zip code.

20. The method of claim 17, wherein the application program interface is linked to the database for retrieving the postal address using its corresponding virtual address.

21. The method of claim 20, wherein a merchant enters the virtual address into the application program interface to retrieve the postal address corresponding to the virtual address provided by the consumer.
